(19) United States
(12) Patent Application Publication
(10) Pub. No.: US 2006/0078704 A1
(43) Pub. Date: Apr. 13, 2006

(54) Interlocking waney edge glue system

(76) Inventor: Michael G. Holzhey, Kelowna (CA)

Correspondence Address: Clifford W. Vermette, Vermette & Co.;Box 40, Granville Square, Suite 230, 200 Granville Street, Vancouver, BC, V6C 1S4, CA

(21) Appl. No.: 10/961,059

(22) Filed: Oct. 12, 2004

(51) Int. Cl. B32B 3/00

(52) U.S. Cl. 428/60

(57) ABSTRACT

A composite edge-glued wood product, comprising profiled pieces of lumber bonded and pressed together. The profiled pieces of lumber are made from waney lumber, which has been profiled such that the waney edges thereof have been removed to reveal profiled edges. The profiled edges each have at least one protrusion and one indentation. Interlocking engagement of the profiled pieces of lumber prevents lateral movement of adjacent profiled pieces of lumber relative to one another when the composite wood product is pressed. The invention makes use of waney lumber to make composite edge-glued wood products. The use of a standard edge glue press takes advantage of inexpensive conventional technology.

### FIELD OF THE INVENTION

The present invention relates to an interlocking waney edge glue system for utilizing waney lumber to produce composite wood products and thereby reduce waste. In particular, the present invention relates to profiled wood articles made from waney lumber and a system for using the profiled wood articles to manufacture composite edge-glued wood products.

### BACKGROUND OF THE INVENTION

The production of standard lumber inevitably results in waste in the form of waney lumber, or boards or pieces of lumber that, instead of being cut square, show the original curve of the log from which they are cut. Due to the curvature and irregular shape of waney lumber, it is difficult to use in the manufacture of wood products. Its low cost, on the other hand, makes it a potentially useful raw material. Many composite wood products are made by gluing and pressing pieces of lumber together. To carry out such a lamination of lumber, each of the pieces of lumber used must have complementary surfaces that provide a good joining surface. As waney lumber has irregular surfaces that do not facilitate lamination, waney lumber must be further processed to provide complementary uniform surfaces before it can be used to produce composite wood products. A typical approach to utilizing waney lumber has been to simply saw off the waney portion of the board. Such an approach results in a great deal of waste of waney fiber.

As forests are a precious resource, and as there is a need to conserve forests, the minimization of waste is desirable. Consequently, there is a need in the art for a means of utilizing waney lumber to obtain composite wood products with a minimum of waste.

Previously disclosed methods of utilizing waney lumber have further deficiencies and limitations that negatively impact the efficiency of making composite products from waney lumber, or the durability of such products. Known methods often do not produce strong joints between adjacent pieces of waney lumber due to insufficient contact area for the joint, and non-uniform contact between profiled edges. Profiling refers to the reshaping of waney lumber to remove the irregular rounded surfaces. In addition, the edge profiles of the prior art are such that complex pressing machinery (e.g. two-dimensional presses) is required. Such presses significantly increase the cost of the final composite product due to the cost and complexity of the press itself, a more complex manufacturing process and the relatively low throughput.

Key to producing waney wood composite products that are commercially feasible is that the products must be durable as well as easy to produce. Ideally, the profiled edges between adjacent pieces of lumber are shaped such that they provide a strong joint, permit the use of conventional pressing equipment, and allow a standard manufacturing process.

U.S. Pat. No. 5,870,876, issued to Deiter, discloses a composite wood product made from a plurality of identical profiled pieces of lumber having identical and complementary profiled edges. However, the profile used in Deiter is such that a two dimensional press is required because the profiled edges do not interlock in a manner that prevents lateral movement of adjacent pieces of profiled lumber. Therefore, if a one dimensional press is used, the glue lines perpendicular to the press plates don't receive any pressure and the profiled pieces of lumber are likely to shift during the pressing process.

Accordingly, it is an object of the present invention to provide a composite wood product and means for the manufacture thereof, that makes efficient use of waney lumber (i.e. cost effective use resulting in a minimum of fiber waste) and that requires only a conventional one dimensional edge glue press during the manufacturing process.

### SUMMARY OF THE INVENTION

A composite edge-glued wood product, comprising profiled pieces of lumber bonded and pressed together. The profiled pieces of lumber are made from waney lumber, which has been profiled such that the waney edges thereof have been removed to reveal profiled edges. The profiled edges each have at least one protrusion and one indentation, and each of the profiled edges extends from the top surface and the bottom surface of the respective profiled piece of lumber.

The profiled pieces of lumber are arranged side by side in parallel relation and adjacent profiled pieces are inverted with respect to one another such that the top and bottom surfaces of the composite wood product are formed by alternating top and bottom surfaces of the profiled pieces.

Each of the profiled edges is complementary to and engageable with adjacent profiled edges on adjacent and inverted profiled pieces of lumber such that adjacent profiled pieces of lumber are in close-fitting and interlocking engagement with one another by mutual interlocking engagement of their respective profiled edges.

The interlocking engagement of the profiled pieces of lumber prevents lateral movement of adjacent profiled pieces of lumber relative to one another when the composite wood product is pressed. During manufacture, adjacent profiled edges are bonded to one another by adhesive, and the composite wood product is pressed in one dimension in a manner operative to force adjacent profiled edges against one another. Accordingly, in the preferred embodiments the profiled edges do not have portions or faces parallel to the top and bottom surfaces because such portions or faces would not receive pressure when the profiled pieces of lumber are pressed in a conventional edge gluing press. In addition, depending on the precise configuration of the profiled edges in question, it may be more difficult to apply glue to such portions or faces.

The present invention additionally contemplates a method of making the composite wood product. The first step in the method is to provide elongated pieces of waney lumber which are then profiled by removing the waney edges thereof to reveal profiled pieces of lumber having profiled edges. Each of the profiled edges has at least one protrusion and one indentation, and each of the profiled edges extends from the top to the bottom surface of a respective profiled piece of lumber. Adhesive is then applied to the profiled edges, and the profiled pieces of lumber are arranged side by side in parallel relation such that adjacent profiled pieces of lumber are inverted with respect to one another and such that adjacent profiled edges come into close-fitting interlocking engagement. The profiled pieces are arranged such the top and bottom surfaces of the composite wood product are formed by alternating top and bottom surfaces of the profiled pieces of lumber.

The close fitting interlocking engagement the adjacent profiled pieces is operative to prevent lateral movement of adjacent profiled pieces of lumber relative to one another.

The interlocked profiled pieces of lumber are then pressed together in one dimension such that the adjacent profiled edges are forced against one another.

The invention makes use of waney lumber, which is a presently underutilized and readily available raw material, to make composite wood products. Further, the invention makes use of waney fiber in an economical way. The use of a one-dimensional edge glue press takes advantage of inexpensive conventional technology.

The invention also enables the manufacture of edge-glued composite products from material with wane only on one side as well as square-edge material.

Other objects and advantages of the invention will become clear from the following detailed description of the preferred embodiment, which is presented by way of illustration only and without limiting the scope of the invention to the details thereof.

### BRIEF DESCRIPTION OF THE DRAWINGS

Further features and advantages will be apparent from the following Detailed Description of the Invention, given by way of example, of a preferred embodiment taken in conjunction with the accompanying drawings, wherein:

FIG. 1 is a cross section of waney lumber having two waney edges;

FIG. 2 is a cross section of profiled lumber having both edges profiled;

FIG. 3 is a cross section of a composite wood product formed from profiled lumber;

FIG. 4 is a cross section of a prior art composite wood product formed by combining prior art profiled lumber;

FIG. 5 is a cross section of a prior art composite wood product formed using square-edged lumber;

FIG. 6 is a cross section of a prior art composite wood product formed by combining prior art profiled lumber;

FIG. 7 is a cross section of waney lumber having one waney edge;

FIG. 8 is a cross section of profiled lumber having one profiled edge;

FIG. 9 is a cross section of a composite wood product formed by combining profiled lumber having one profiled edge;

FIG. 10 is a cross section of a log showing waney lumber produced as a byproduct when producing standard lumber;

FIGS. 11 to 14 are illustrations of various additional profiled edges; and

FIG. 15 is a flow chart of the method of manufacturing the composite wood products of the present invention.

### DETAILED DESCRIPTION OF THE INVENTION

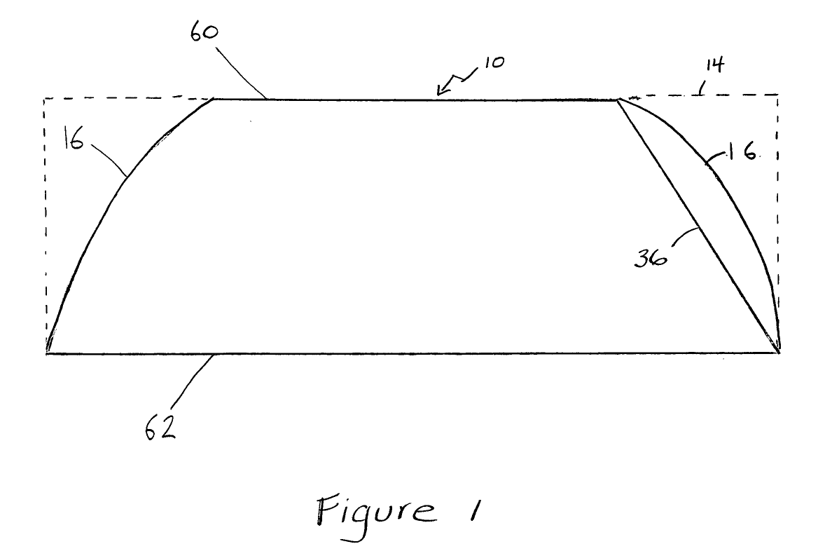

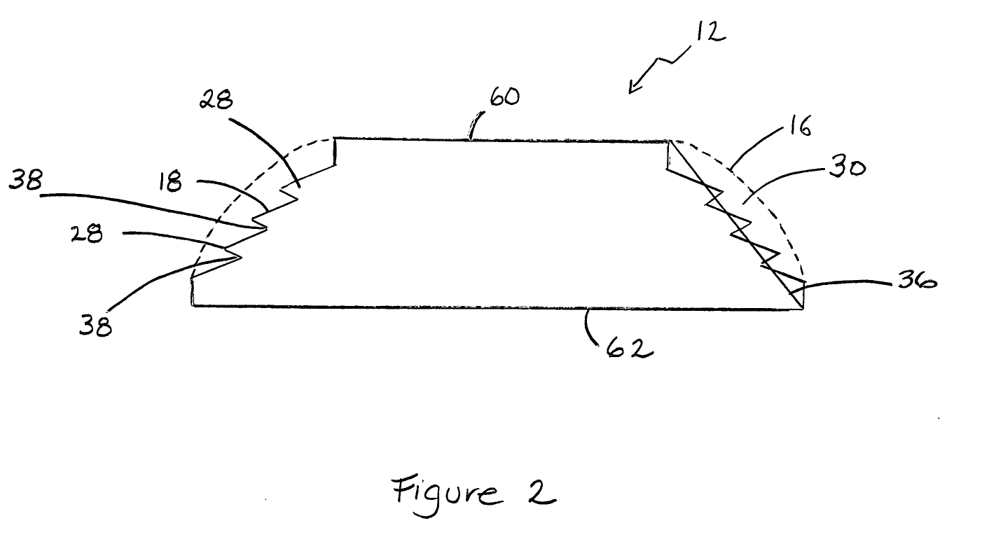

FIGS. 1 and 2 illustrate an elongated piece of waney lumber 10, having an upper surface 60, a lower surface 62, and waney edges 16, and a profiled piece of lumber 12 made therefrom. The elongated piece of waney lumber 10 and the profiled piece of lumber 12 are shown in cross-section (i.e. the longitudinal axes of the piece of waney lumber 10 and the profiled piece of lumber 12 extend perpendicularly out of the page). Waney lumber usually results as a byproduct from the production of standard lumber as a consequence of the curvature of the tree from which the lumber is produced. By way of example, the elongated piece of waney lumber 10 is illustrated as being a waney byproduct from the production of standard 2×6 lumber; the dotted outline 14 indicates the shape that a standard 2×6 piece would have.

The rounded, irregular surface of the waney edge 16 makes the elongated piece of waney lumber 10 unsuitable for use in the manufacture of composite wood products because it is not possible to achieve a strong and uniform bond between the waney edge 16 and other components of composite wood products. Cutting off the entire waney portion to produce a lumber product with a rectangular cross section would result in much waste. It is desirable to utilize a maximum of the waney fiber for purposes of manufacturing composite wood products.

FIG. 2 shows a profiled piece of lumber 12 obtained by profiling the elongated piece of waney lumber 10 of FIG. 1. The dotted line in FIG. 2 indicates the waney edge 16 of the original waney lumber 10. The process of profiling amounts to the removal of the waney portions 30 from the original waney lumber 10 to form profiled edges 18.

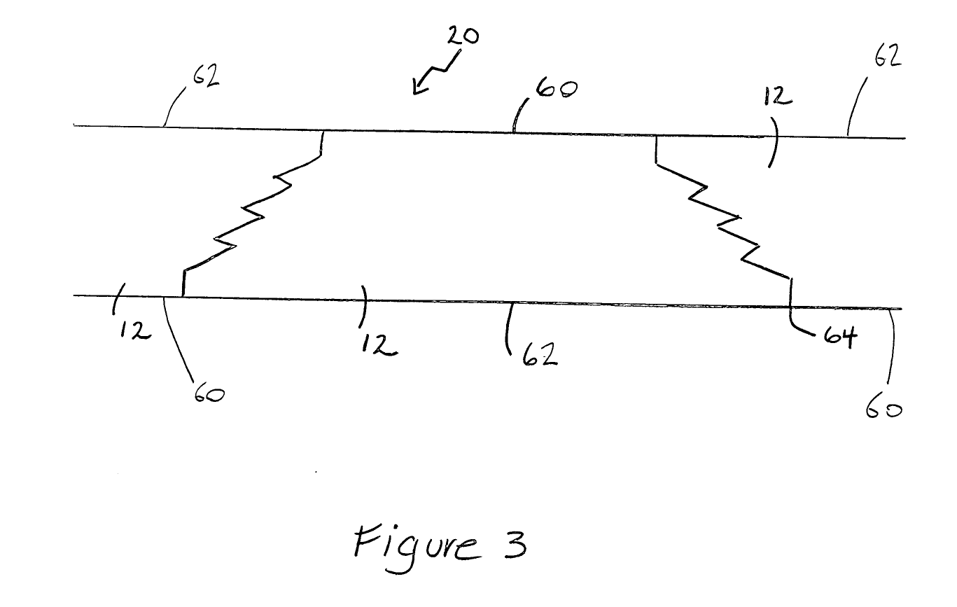

Profiled lumber 12 is shaped such that the profiled edge 18 has protrusions 28 and indentations 38, and so as to be complementary to a profiled edge of an adjacent piece of profiled lumber. Referring to FIG. 3, two or more pieces of profiled lumber 12 may be combined to produce a composite wood product 20. Adjacent pieces of profiled lumber 12 are inverted with respect to one another such that the top and bottom surfaces of the composite wood product 20 are comprised of alternating top 60 and bottom 62 surfaces of the profiled pieces of lumber 12.

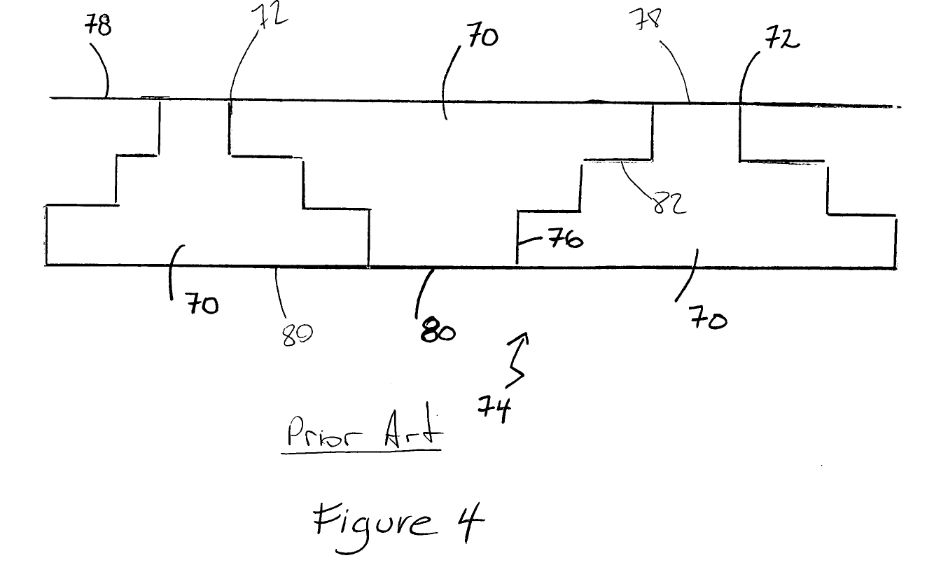

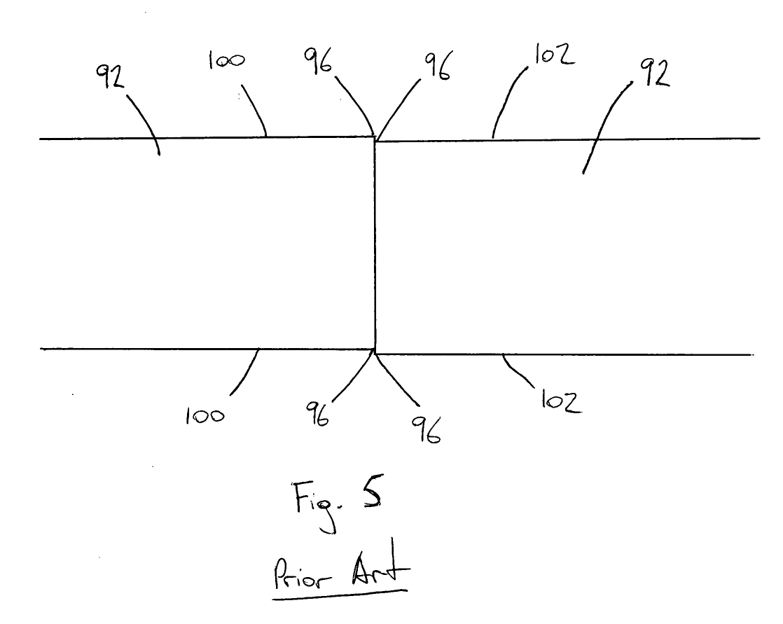

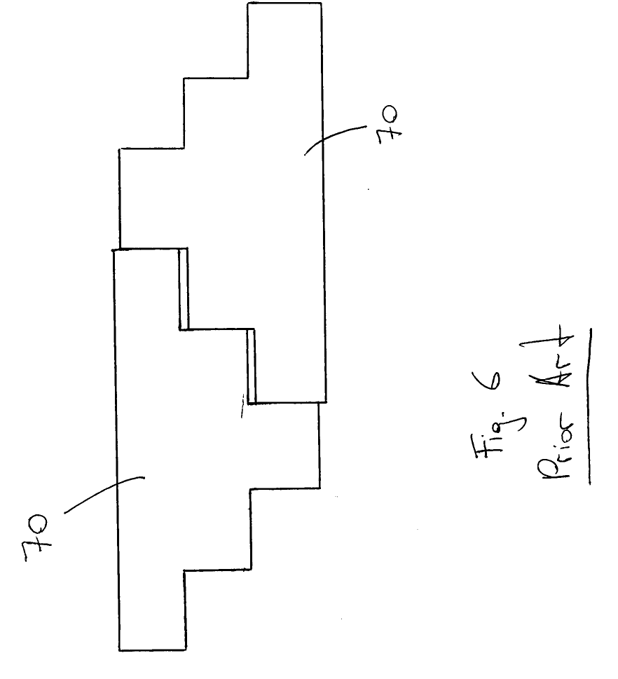

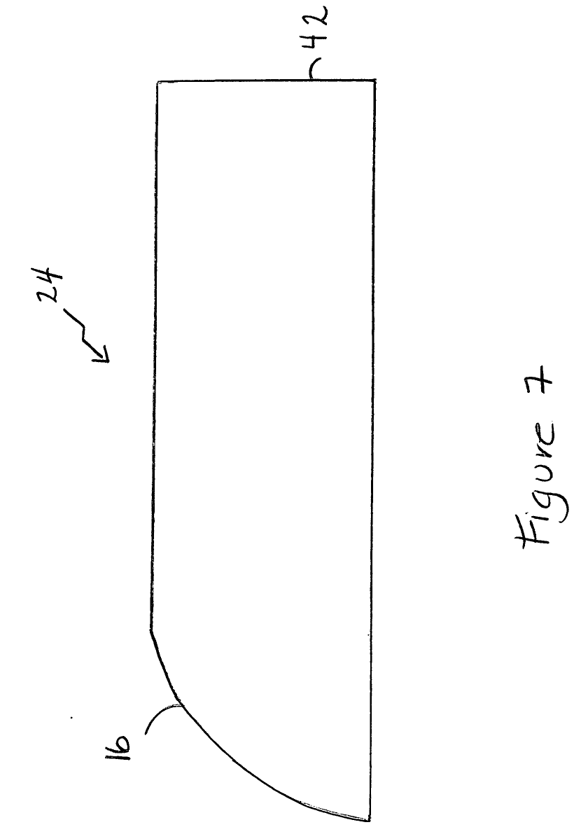

FIG. 4 shows prior art (see U.S. Pat. No. 5,870,876) in which a profiled piece of lumber 70 has a profiled edge 72, which profiled edge 72 contacts a similar profiled edge 72 of an adjacent profiled piece 70 to form a composite wood product 74. During the manufacture of the prior art composite wood product 74, the profiled pieces 70 must be pressed simultaneously in two dimensions. Pressing in the first dimension is achieved by applying equal and opposite forces to the upper 78 and lower surfaces 80 such that the horizontal portions 82 of the profiled edges 72 of adjacent profiled pieces 70 are forced against one another. The second dimension is orthogonal to the first and pressing in the second dimension is achieved by applying equal and opposite forces to the left and right sides of the composite product 74 such that the vertical portions 76 of adjacent ones of the profiled pieces 70 are forced against one another. If pressing is performed in only one dimension the. profiled pieces 70 may shift relative to one another along either the vertical portions 76 or horizontal portions 82, whichever are perpendicular to the pressing force and the glue line (i.e. vertical portions 76 or horizontal portions 82) parallel to the pressing force will not receive any pressure at all, creating no bond.

Referring to FIGS. 2 and 3, profiled edges 18 are shaped such that protrusions 28 and indentations 38 of each piece of profiled lumber 12 engage the protrusions 28 and indentations 38 of an adjacent piece of profiled lumber 12 when two or more pieces of profiled lumber 12 are joined together to form composite wood product 20. During the manufacturing process the profiled pieces of lumber 12 are pressed together along one dimension (in contrast with the prior art as discussed above in relation to FIG. 4). The pressing step is achieved by applying equal and opposite forces to either side of the composite wood product 20 along an axis parallel to the upper and lower surfaces 60, 62 such that the profiled edges 18 of adjacent profiled pieces of lumber 12 are forced together (i.e. the profiled pieces 12 are pressed together from the left and right as viewed in FIG. 3). The mutual engagement of the protrusions 28 and indentations 38 during the pressing process prevents movement of the profiled pieces of lumber 12 relative to one another in a direction perpendicular to the upper and lower surfaces 60, 62 and to the longitudinal axes of the profiled pieces of lumber 12, and allows for pressure being applied to all glue lines while being pressed. In other words, protrusions 28 and indentations 38 are so shaped as to make a composite wood product 20 resistant to lateral movement at joint 64 during the pressing process and to create a strong durable glue line.

Preferably, the profiled edges 18 do not have portions or faces parallel to the upper and lower surfaces 60, 62 because such portions or faces would not receive pressure when the pieces of lumber 12 are pressed in a conventional edge gluing press, and because, depending on the precise configuration of the profiled edges 18 in question, it may be more difficult to apply glue to such portions or faces.

The profiled pieces of lumber 12 in FIG. 3 have identical profiled edges 18. A less complex and more efficient process of manufacturing composite wood products results from this as the same milling head may be used on each piece of waney lumber 10, and, furthermore, on each waney edge 16 of each piece of waney lumber 10. In addition, any two adjacent profiled pieces of lumber 12 selected from a plurality of such pieces 12 can be fit together.

As a consequence of the shape of profiled edges 18, pieces of profiled lumber 12 mate precisely, thereby reducing, if not eliminating, any need for planing the surfaces of composite wood product 20. As illustrated in FIG. 5, in the prior art there arises the problem of alignment of the component pieces of lumber 92 as the flat profile does not prevent lateral movement of the pieces of lumber 92 during the process of gluing and pressing. As illustrated in FIG. 6, a similar problem is encountered in the manufacture of prior art composite wood products. If a one dimensional press is used, the wood products 70 can shift during the pressing step (the adhesive applied between the wood products 70 can act as a lubricant) resulting in a loss of alignment. As a result of such shifting, the integrity of the joints between adjacent pieces of prior art profiled pieces of lumber 70 is compromised, and the surface of the resulting composite product is uneven.

As stated above, and with reference to FIG. 3, the present invention makes use of profiled lumber 12 having profiled edges 18 shaped so as to: (a) allow precision mating of adjacent pieces of profiled lumber 12; (b) resist lateral movement of adjacent pieces of profiled lumber 12 such that composite products may be made by pressing in only one dimension; and (c) create a strong durable glue line. Adjacent pieces of profiled lumber 12 automatically interlock for a precision fit upon the exertion of pressure from either side in the direction of joint 64 (i.e. pressed in one-dimension so as to force profiled edges 18 of adjacent pieces of profiled lumber 12 together).

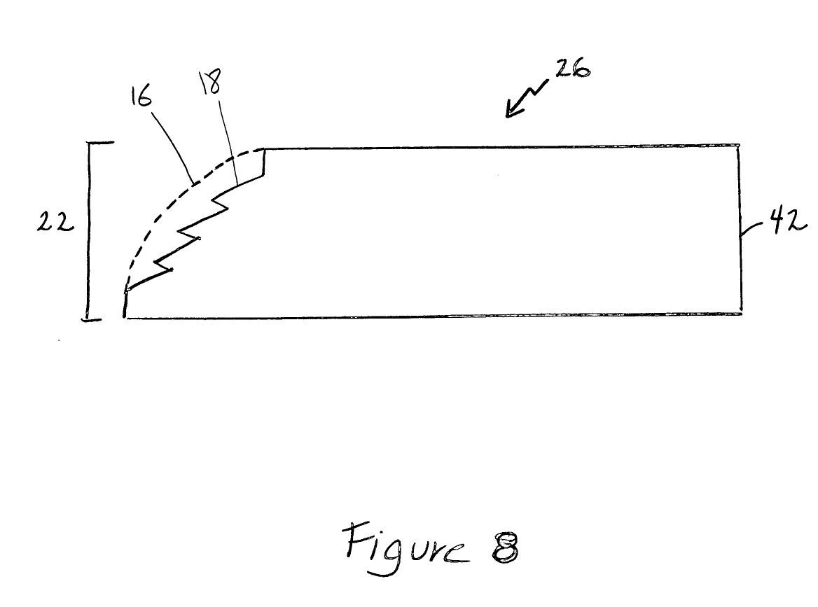

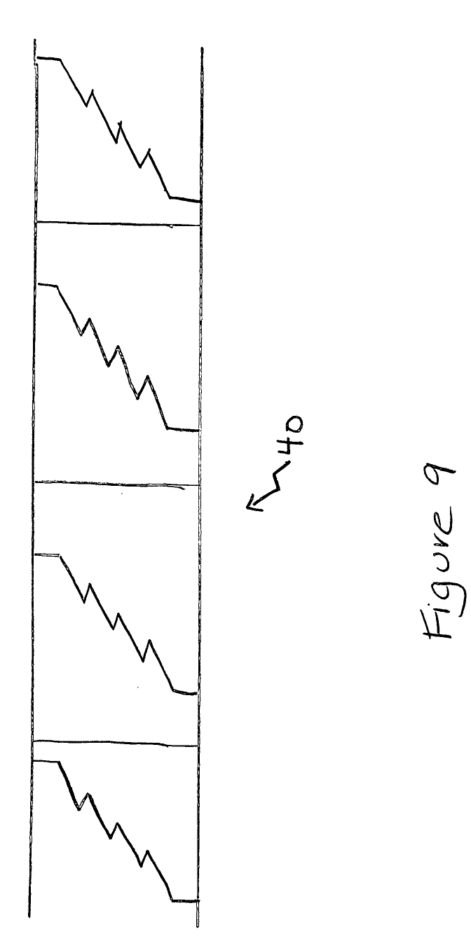

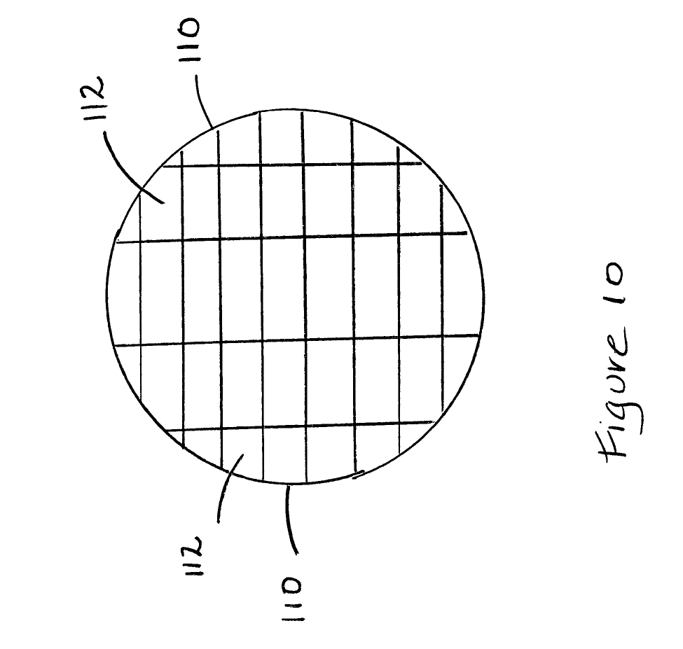

FIGS. 7 to 9 illustrate a piece of waney lumber 24 having one waney edge 16, a piece of profiled lumber 26 made therefrom having one profiled edge 18, and a composite wood product 40 made from such profiled pieces of lumber. The square edge 42 of profiled lumber 26 may be joined with square edge 42 of another piece of profiled lumber 26 or standard lumber (having a rectangular cross section) in order to form a composite wood product. FIG. 9 shows a composite wood product 40 made of a plurality of profiled pieces of lumber 26. The embodiment of FIG. 9 serves to demonstrate that the present invention is compatible with prior art edge gluing systems.

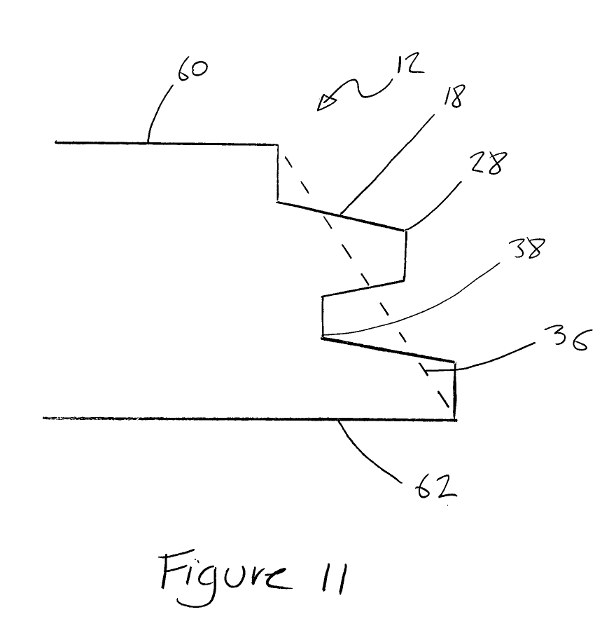

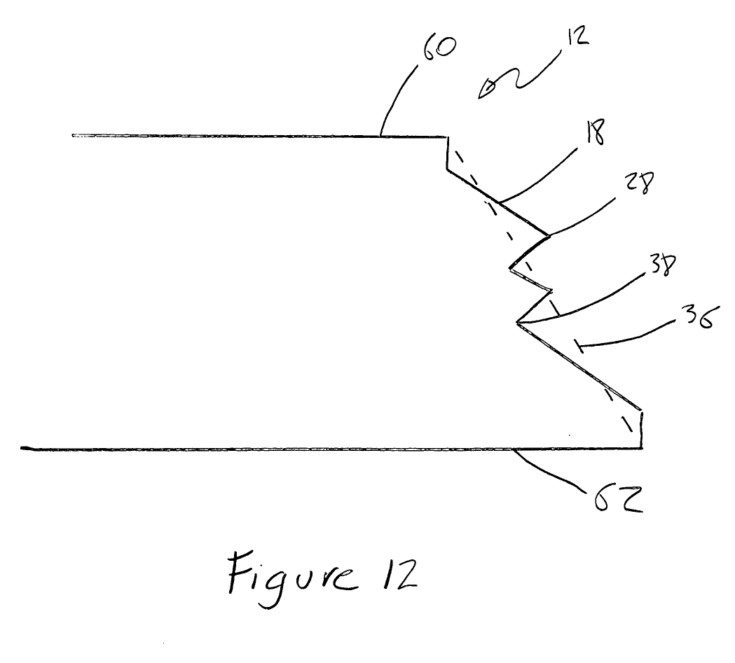

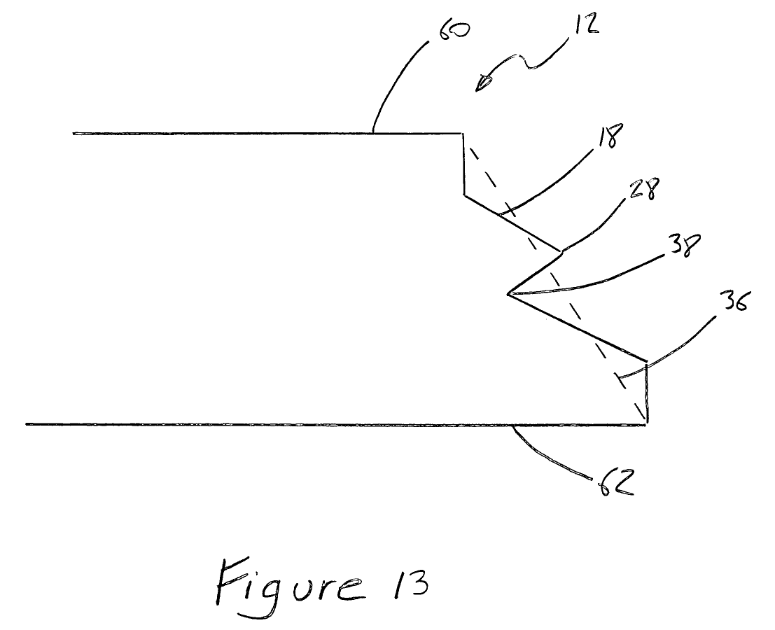

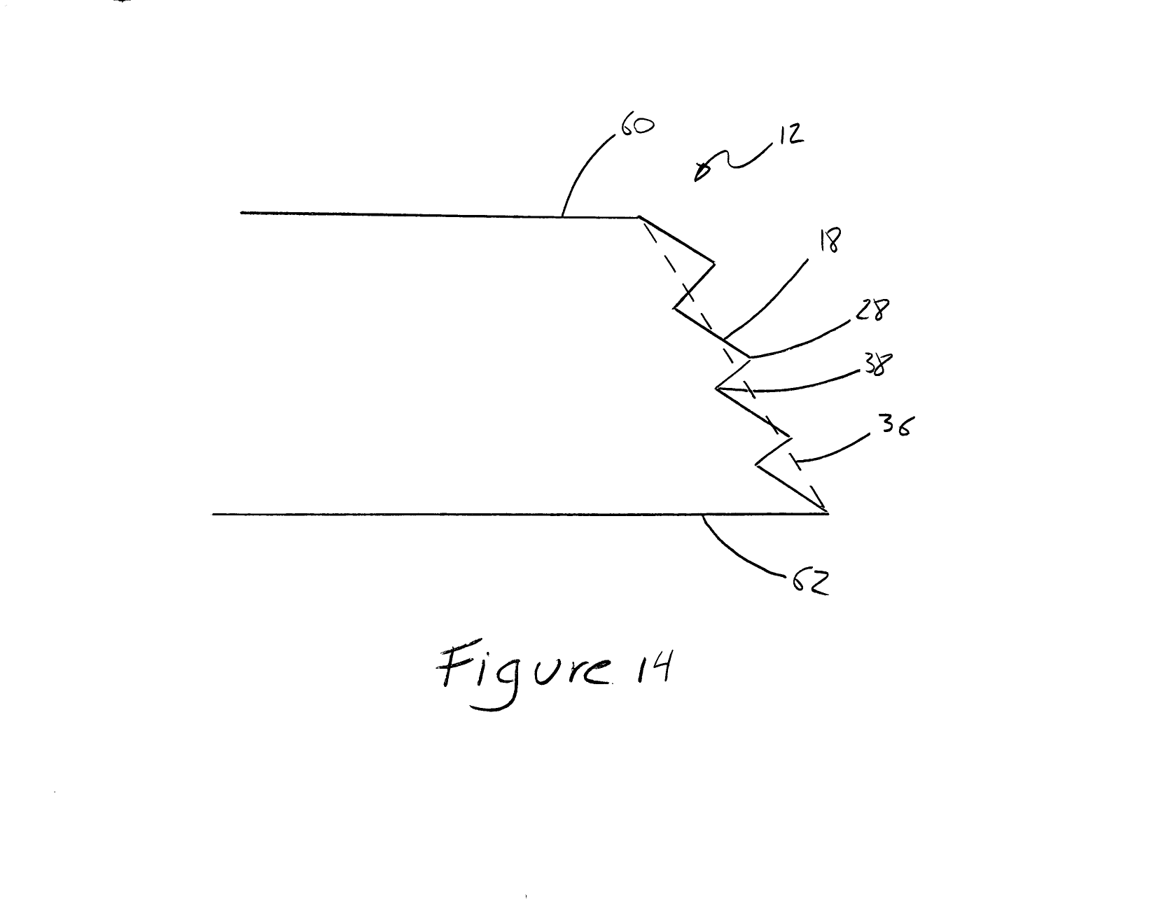

A further aspect of the present invention is that one single profile is used on all the profiled edges 18 of all the profiled pieces of wood 12, 26 so that the process of milling waney lumber into profiled lumber, and the process of assembling the profiled lumber into composite wood products is simplified. In order for a single profile to be used on all of the profiled pieces of lumber 12, 26, the profile must have a certain degree of symmetry, such that any one profiled edge will mate with an identical profiled edge that is inverted with respect thereto. FIGS. 11 to 19 illustrate several alternative profiles 18 that exhibit such symmetry, while also exhibiting the characteristics of preventing lateral movement of adjacent profiled pieces of lumber and minimizing waste of waney fiber.

In a preferred embodiment, the choice of profile of the profiled edges 18 is made so as to maximize the utilization of waney lumber through the selection of a profile that most closely follows the original waney edge 16. In general, waney edges will have a surface that, in cross section, resembles an arc (as illustrated in FIG. 1).

Referring to FIGS. 1, 2 and 11-14, several examples are shown of profiled edges 18 demonstrating the necessary symmetry about line 36 such that, given two pieces of profiled lumber 12, each having the same profiled edges 18 selected from FIGS. 1, 2 and 11-14, the profiled edges are complementary to one another and interlockingly fit together in a manner that prevents lateral movement of the two profiled pieces of lumber relative to one another.

In addition, in the preferred embodiment of the invention the configuration of the profiled edges 18 is selected such that a maximum of waney fiber is retained (i.e. fiber waste is minimized).

The profile chosen for the profiled edge 18 of any given embodiment of the present invention can be chosen according to several criteria such as, for example, the degree of wane, the quality of the lumber, the machinery and/or tools available, the application for which the composite wood product is intended to be used, etc.

The present invention additionally contemplates a method for manufacturing composite wood products, as is shown in FIG. 15. The process of fabricating composite wood products begins with conventional lumber, running it through a moisture meter 140 and sorting it in the chop line 150 into different lumber sorts 160. Wet lumber 170 is kiln dried 180 when required. The sorting 150 produces both square-edged lumber 192 and waney lumber 194. Although the present invention is particularly advantageous in that it maximizes utilization of waney lumber, it is applicable to square-edged lumber as well. As discussed above, waney lumber is lumber cut from near the outside of the log and one or two edges are rounded off and irregular. At step 200, the shorter lumber pieces may be finger jointed to achieve the requisite length.

After finger jointing 200 the lumber is profiled 210 to provide profiled edges 18, (see FIGS. 2, 3 and 11-14). The profiling step 210 also makes it possible to utilize waney lumber that previously was not useable in composite construction. The profiling step 210 removes the waney portions of the waney lumber or square edges in the case of square edged lumber.

The profiled lumber is then trimmed, laid up, glued and pressed 220 together to form a composite wood product. This step involves the application of adhesive in the interfaces joints 64 between the profiled edges of adjacent profiled pieces of lumber 12, 26 (see FIGS. 2, 3, 8 and 9). Once the adhesive has been applied the profiled pieces of lumber 12, 26 are processed 220 in a conventional edge-gluing press. No pressing is required in a second dimension because the profiling of the lumber prevents lateral movement of the lumber during the pressing process. Once the glue has set, the product is finished 230 and packaged for shipping 240 or further processed 250.

Preferably, the adhesive or bonding material is applied to substantially all surfaces of profiled edge 18. The present invention provides an additional advantage over the prior art method of producing composite wood products, which method utilizes square-edged lumber (whether originally waney lumber or not), as the profiled edge 18 has a greater surface area than the square edge for adhesion, and thereby allows for a stronger joint between adjacent profiled pieces of lumber 12, 26.

Composite wood products formed from the profiled lumber provide significant improvements in resistance to shearing and impact forces and improved load bearing capacity. Composite wood products further avoid many of the complex reinforcing requirements of the prior art. In addition, the significant resistance to shearing and impact forces achieved in the composite wood products above permits the use of wood pieces from old growth and stagnant growth timber as well as younger generation timber for a much broader application of use in the lumber industry.

Accordingly, while this invention has been described with reference to illustrative embodiments, this description is not intended to be construed in a limiting sense. Various modifications of the illustrative embodiments, as well as other embodiments of the invention, will be apparent to persons skilled in the art upon reference to this description. It is therefore contemplated that the appended claims will cover any such modifications or embodiments as fall within the true scope of the invention.

We claim:

1. A composite edge-glued wood product, comprising a plurality of profiled pieces of lumber bonded and pressed together, wherein said profiled pieces of lumber are made from waney pieces of lumber which have been profiled such that waney edges thereof have been removed to reveal profiled edges, said profiled edges of said profiled pieces of lumber each having at least one protrusion and one indentation, and each of said profiled edges extending between a top surface and a bottom surface of a respective one of said profiled pieces;
wherein said profiled pieces of lumber are arranged side by side in parallel relation and wherein-adjacent ones of said profiled pieces are inverted with respect to one another such that top and bottom surfaces of said composite wood product are formed by alternating top and bottom surfaces of said profiled pieces;
wherein each of said profiled edges is complementary to and engageable with an adjacent one of said profiled edges on an adjacent and inverted one of said profiled pieces of lumber such that adjacent ones of said profiled pieces of lumber are in close-fitting and interlocking engagement with one another by mutual interlocking engagement of their respective profiled edges;
wherein said interlocking engagement of said adjacent profiled pieces of lumber prevents lateral movement of said adjacent profiled pieces of lumber relative to one another when said composite wood product is pressed in one dimension in a manner operative to force adjacent ones of said profiled edges against one another; and
wherein adjacent ones of said profiled edges are bonded to one another by adhesive.

2. The composite wood product of claim 1, wherein all of said profiled edges have identical profiles.

3. The composite wood product of claim 1, wherein one or more of said profiled pieces of lumber is finger jointed.

4. The composite wood product of claim 1, wherein one or more of said elongated waney pieces of lumber has only one waney edge.

5. The composite wood product of claim 1, wherein profiles of said profiled edges are selected with a view to minimizing waste of waney fiber.

6. The composite wood product of claim 1, wherein said protrusions and said indentations extend longitudinally along a length of respective ones of said profiled pieces of lumber.

7. The composite wood product of claim 1, wherein all portions of said profiled edges are non-parallel to said top and bottom surfaces.

8. A method of making a composite edge-glued wood product, comprising:
(a) providing a plurality of elongated pieces of waney lumber;
(b) profiling said pieces of waney lumber to remove waney edges thereof to reveal profiled pieces of lumber having profiled edges, each one of said profiled edges having at least one protrusion and one indentation, each of said profiled edges extending between a top and a bottom surface of a respective one of said profiled pieces of lumber;
(c) applying an adhesive to said profiled edges;
(d) arranging said profiled pieces of lumber side by side in parallel relation such that adjacent ones of said profiled pieces of lumber are inverted with respect to one another and such that said profiled edges of adjacent ones of said profiled pieces of lumber come into close-fitting interlocking engagement such that top and bottom surfaces of said composite wood product are formed by alternating top and bottom surfaces of said profiled pieces of lumber, said close fitting interlocking engagement operative to prevent lateral movement of adjacent ones of said profiled pieces of lumber;
(e) pressing said plurality of interlocked profiled pieces of lumber in one dimension such that said profiled edges of adjacent ones of said profiled pieces of lumber are forced together.

9. The method of claim 8, wherein all of said profiled edges have identical profiles.

10. The method of claim 8, wherein one or more of said profiled pieces of lumber is finger jointed.

11. The method of claim 8, wherein said providing step includes sawing logs into lumber, kiln drying, finger-jointing and planing.

12. The method of claim 8, wherein one or more of said elongated waney pieces of lumber has only one waney edge.

13. The method of claim 8, wherein profiles of said profiled edges are selected with a view to minimizing waste of waney fiber.

14. The method of claim 8, wherein said protrusions and said indentations extend longitudinally along lengths of respective ones of said profiled pieces of lumber.

15. The method of claim 8, wherein said pressing step is carried out by a one-dimensional press.
